(19) United States
(12) Patent Application Publication
(10) Pub. No.: US 2026/0368062 A1
(43) Pub. Date: Nov. 19, 2026

(54) DELIVERY AND REMOTE MANAGEMENT OF AI-RELATED CONFIGURATION DATA TO DEPLOYED SOFTWARE APPLICATIONS

(71) Applicant: Catamorphic Co. dba LaunchDarkly, Oakland, CA (US)

(72) Inventors: Benjamin Hale Woskow, Oakland, CA (US); Claire Vo Lawless, San Francisco, CA (US); Cody De Arkland, Roseville, CA (US); Darrin Lin, Antioch, CA (US); Karishma Irani, San Francisco, CA (US); Daniel O'Brien, Bristol, PA (US)

(21) Appl. No.: 19/212,255

(22) Filed: May 19, 2025

(51) Int. Cl. G06F 11/34; G06F 8/71; G06F 9/445

(52) U.S. Cl. CPC G06F 11/3447; G06F 8/71; G06F 9/44505

(57) ABSTRACT

Various example embodiments described provide for systems, methods, devices, techniques, and instructions for delivering and remotely managing artificial intelligence (AI)-related software configuration data with respect to one or more deployed software applications, where the deployed software applications can use the AI-related software configuration data with respect to an AI-related software feature of the deployed software applications. For example, an example embodiment can facilitate dynamic configuration of AI software features of a deployed software application operating on a remote computing device based on one or more contextual attribute values of an entity (e.g., user or organization) associated with the remote computing device.

### TECHNICAL FIELD

The present disclosure relates generally to software applications and, more specifically, to systems, methods, devices, techniques, and instructions for delivering and remotely managing artificial intelligence (AI)-related software configuration data with respect to one or more deployed software applications, where the deployed software applications (e.g., production or general release client software applications) can use the AI-related software configuration data with respect to an AI-related software feature of the deployed software applications.

### BACKGROUND

Artificial intelligence and machine learning systems have introduced new complexities in software deployment and configuration management. Software applications (e.g., deployed to client or server devices) increasingly rely on AI models and configurations that determine how these models process and respond to inputs. Managing these AI systems requires coordinating multiple components, including model selection, parameter tuning, and prompt engineering. The non-deterministic nature of AI outputs creates additional challenges around version control and deployment strategies.

### BRIEF DESCRIPTION OF THE DRAWINGS

The disclosure will be understood more fully from the detailed description given below and from the accompanying drawings of various example embodiments of the disclosure. The drawings, however, should not be taken to limit the disclosure to the specific example embodiments, but are for explanation and understanding only. To easily identify the discussion of any particular element or act, the most significant digit or digits in a reference number refer to the figure number in which that element is first introduced.

FIG. 1 is a diagrammatic representation of an example AI configuration delivery and management system for deployed software applications in a networked environment in which the present disclosure may be deployed, in accordance with some example embodiments of the present disclosure.

FIG. 2 is a block diagram illustrating an example implementation of an AI configuration delivery and management system, in accordance with some example embodiments of the present disclosure.

FIG. 3 is a flowchart illustrating an example method for delivering and remotely managing AI-related software configuration data with respect to one or more deployed software applications on one or more remote computing devices, in accordance with some example embodiments of the present disclosure.

FIG. 4 through FIG. 6 illustrate example graphical user interfaces that can be used by a user to configure and manage AI configuration delivery, in accordance with some example embodiments of the present disclosure.

FIG. 7 is a diagrammatic representation of a machine in the form of a computer system within which a set of instructions may be executed for causing the machine to perform any one or more of the methodologies discussed herein, in accordance with some example embodiments of the present disclosure.

FIG. 8 is a block diagram showing a software architecture within which examples may be implemented.

### DETAILED DESCRIPTION

The description that follows includes systems, methods, techniques, instruction sequences, and computing machine program products that embody illustrative example embodiments of the disclosure. In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, protocols, structures, and techniques are not necessarily shown in detail.

As noted herein, software applications (e.g., deployed to client or server devices) increasingly rely on AI models and configurations that determine how these models process and respond to inputs. Managing these AI systems requires coordinating multiple components, including model selection, parameter tuning, prompt engineering, and the like. Additionally, the non-deterministic nature of AI outputs creates additional challenges around version control and deployment strategies. Traditional software deployment approaches to devices (e.g., client or server devices) often struggle with the dynamic nature of AI systems. Configuration changes typically require full software application redeployment, limiting flexibility and increasing operational overhead. The distributed nature of modern applications adds further complexity, as AI configurations must be consistently delivered and applied across multiple environments and regions.

Various example embodiments described herein cure these and other deficiencies present in conventional methodologies for managing software configuration information by providing systems, methods, devices, techniques, and instructions for delivering and remotely managing artificial intelligence (AI)-related software configuration data with respect to one or more deployed software applications on remote computing devices (e.g., client devices or servers), where the deployed software applications (e.g., production or general release client software applications) can use the AI-related software configuration data with respect to an AI-related software feature (e.g., AI-based/enabled software feature) of the deployed software applications. Specifically, various example embodiments described herein facilitate dynamic configuration of AI software features of a deployed software application operating on a remote computing device based on one or more contextual attribute values of an entity (e.g., user at the deployed software application, an organization associated with the deployed software application, the device itself) associated with the remote computing device.

A system of various example embodiments can customize, test, and deploy out use of new prompts (e.g., messages) and AI configurations (e.g., configuration to select and use a new AI model, such as a specific version of a generative AI model by a specific model provider) by an AI-related software feature of a deployed software application on one or more remote computing devices. Through use of the system, a user or an organization (e.g., software developer) can manage AI configurations or prompts (e.g., messages) used by a deployed software application outside of application code of the deployed software application, thereby permitting changes (e.g., creation, modification, or deletion) of AI configurations or prompts without redeployment of the application code. For example, a user or organization can cause an AI-related software feature of a deployed software application to select and use a different version of an AI model (e.g., new or upgraded AI models) or a different set or sequence of prompts (e.g., messages). In this way, the system can evaluate and deliver AI-related software configuration data specific to each entity (e.g., user) of an AI-related software feature of a deployed software application, and do so without having to redeploy the deployed software application. Through use of the system, a user or organization can cause different instances of a deployed software application (e.g., on different remote computing devices) to use different variations of AI configurations or prompts (e.g., messages) based on their associated entity (e.g., the entity using the deployed software application), which can facilitate testing (e.g., A/B testing on configuration changes) and gradual rollout of different variations of AI configurations or prompts to instances of the deployed software application on one or more remote computing devices. Additionally, through use of the system, a user or organization can deploy and then compare the performance of different variations of AI configurations, prompts (e.g., messages), or both, which can enable improvements or configuration roll back (e.g., in the event of that performance regression is detected).

According to various example embodiments, a system (e.g., comprising an AI configuration delivery and management server) receives a request for AI configuration information from a deployed software application (e.g., an instance or copy of the deployed software application) operating on a remote computing device. For various example embodiments, the request is associated with an entity of the deployed software application, such as a user using the deployed software application, an organization using the deployed software application, or the remote computing device that is operating (e.g., hosting) the deployed software application. In this way, the AI-related software configuration data eventually received from the system can be specifically generated (e.g., assembled) for the entity's use of the deployed software application, and different entities can use the same deployed software application with a different variation of the AI-related software configuration data. The request can comprise a configuration key (e.g., comprising a numeric or alpha-numeric value) that identifies a group of different AI configuration variations. The group of different AI configuration variations can be used to target, for example, to different entity (e.g., user or organization) cohorts for use cases like internal testing, A/B testing, experimentation, and entitlements management. The group of different AI configuration variations can be stored or otherwise organized as part of an AI configuration resource object on the system, where the AI configuration resource object is associated with (e.g., identified by) the configuration key, and where the AI configuration resource object can also include one or more target rules applicable for determining (e.g., identifying) the AI configuration variation (e.g., subset of AI-related software configuration data items) to be used to generate a response to the request. The request can comprise context data (e.g., context data object) comprising a set of attribute values (for attributes) associated with the entity. Additionally, the request can comprise one or more user-defined variables that provide user-defined variable values, which can be used by the system in servicing the request (e.g., generating prompts based on prompt templates).

The system can retrieve (from a data store, such as a database) stored data associated with the configuration key, where the stored data comprises a set of data items (hereafter, AI-related software configuration data items). The set of AI-related software configuration data items retrieved can represent the group of different AI configuration variations associated with the configuration key. From the set of AI-related software configuration data items, the system can determine a subset of the set of AI-related software configuration data items based on one or more attribute values from the context data of the request, and can generate select (e.g., entity-specific) AI-related software configuration data based on the subset of AI-related software configuration data items. Eventually, the system can send a response to the (requesting) deployed software application, where the response comprises (e.g., carries as payload data) the select AI-related software configuration data that was generated. The select AI-related software configuration data can comprise one or more data structures that store one or more data items according to a data structure specification or protocol, such as JSON (e.g., JavaScript Object Notation). An example of content in the select AI-related software configuration data is provided below in Table 1.

TABLE 1

{
″model″: {
″modelId″: ″gpt-40″,
″key″: ″custom-value″,
″parameters″ : {
″temperature″: 0.7,
″max tokens″: 150 }
},
″prompt″: [ { ″content″: ″You are an Order Resolution Bot. . . ″ }
], ″_ldMeta″: {
″versionId″: ″unique-identifier″
}
}

The select AI-related software configuration data sent back to the deployed software application can represent an individual AI configuration variation from the group of different AI configuration variations associated with the configuration key. Depending on context data and one or more targeting rules (e.g., associated with the configuration key), an instance (e.g., copy) of a deployed software application (e.g., operating on a first remote computing device) being used by a first entity (e.g., first user or organization) and requesting AI configuration in association with the configuration key would be provided with AI-related software configuration data that is different from the AI-related software configuration data provided to another instance of the deployed software application (e.g., operating on a second remote computing device) that is used by a second entity (e.g., second user or organization) and that requests AI configuration in association with the same configuration key.

Once the select AI-related software configuration data is received by the deployed software application, the deployed software application can operate based on the select AI-related software configuration data. Specifically, an AI-related software feature of the deployed software application can operate based on (e.g., retrieve and make use of) one or more AI-related software configuration data items stored within the (received) select AI-related software configuration data. Depending on the example embodiment, the select AI-related software configuration data can comprise AI model information (e.g., model or version of a generative AI model) specifying an AI model selected for use by an AI-related software feature, one or more parameters for an AI model (e.g., generative AI model) used by an AI-related software feature, or a set of prompts for a generative AI model used by the AI-related software feature.

AI-related software configuration data provided in a response to a request from an instance (e.g., copy) of a deployed software application can represent AI configuration information customized for (e.g., an entity associated with) the instance of the deployed software application based on context data provided in the request from the deployed software application. For example, based on a configuration key provided in the request, a set of AI-related software configuration data items and a set of target rules can be retrieved from a data store (e.g., database). As noted herein, the set of AI-related software configuration data items retrieved can represent the group of AI-configuration variations associated with the configuration key. From the set of AI-related software configuration data items retrieved, a subset of AI-related software configuration data items can be determined (e.g., selected or identified) based on one or more attribute values from the context data, where the subset of AI-related software configuration data items correspond to an individual AI configuration variation of the group of different AI configuration variations. For instance, the subset of AI-related software configuration data items can comprise different variations of a max token parameter for different types of generative AI models or for different versions of a particular generative AI model (e.g., Claude model). Then, based on the one or more target rules (retrieved based on the configuration key) and one or more attribute values from the context data, a specific variation of the max token parameters (e.g., meant for an AI-related software feature that uses a certain type of generative AI model, such as a GPT model) can be determined (e.g., selected, identified) and included in the AI-related software configuration data of the response sent back to the deployed software application. Additionally, where an AI-related software configuration data item of the subset comprises a data item template (e.g., that includes references to one or more variables or one or more attributes), the system can use the data item template (e.g., prompt template) to generate a new data item (e.g., an AI-related software configuration data item) that is specifically generated for the request based on at least a portion of the context data (e.g., one or attribute values from the context data), based on one or more user-defined variable values included in the request, or both. The generated data item can then be included in the AI-related software configuration data of the response sent back to the deployed software application.

For various example embodiments, a distributed, low-latency data delivery network is used to facilitate delivery of requests and responses between one or more remote computing devices (e.g., client devices or servers) and a system (e.g., one or more services) that facilitate delivery and remote management of AI-related software configuration data. For instance, some example embodiments can use a flag delivery network to distribute and manage AI-related software configuration data across one or more different environments, users, or systems.

Use of various example embodiments can enable distribution (e.g., dynamic distribution) and management of AI-related configuration data to deployed software applications (e.g., across one or more different operating environments, users, or systems). Use of various example embodiments can enable exploration of different versions of AI-related software configuration data through experimentation, performance tracking of AI-related software features across different versions of AI-related software configuration data, automatic fallback mechanisms when primary AI-related software configuration data is unavailable, or some combination thereof. Additionally, for purposes of managing AI features, use of various example embodiments can assist users (e.g., administrative users) in monitoring performance metrics of different versions of AI-related software configuration data items, and comparing different versions of AI-related software configuration data items, detecting performance regressions, implementing corrective measures, or some combination thereof. When a regression in performance is detected, some example embodiments can automatically cause the AI-related software feature of a deployed software application to use a previous version of the AI-related software configuration data (e.g., the version of the AI-related software configuration data being used just prior to the last version received). Various example embodiments can also support fallback configuration parameters, where if primary AI-related software configuration data cannot be retrieved, a system can retrieve alternative stored data associated with the fallback parameter, generate secondary AI-related software configuration data, and send the secondary AI-related software configuration data in a response to a deployed software application. Overall, various example embodiments described herein can provide or enable a platform that can manage AI-related software features of deployed software applications and AI-related software configuration data used by such software features.

Various embodiments provide for a technical solution for delivering and managing AI-related configuration data for deployed software applications. For instance, various embodiments provide for a technical solution for improving creating and managing configuration of AI-related software features based on contextual information (e.g., attribute values of an entity) associated with deployed software applications. Various embodiments provide for a technical solution for tracking and monitoring performance metrics of AI-related software features to detect performance regressions and implement corrective actions. By providing contextually appropriate AI-related software configuration data, various embodiments provide a technical solution for optimizing AI-related software feature performance for software applications deployed across different environments and user contexts. Additionally, various embodiments provide a technical solution for conducting experiments with different versions of AI-related software configuration data and comparing their performance through associated tracking metrics.

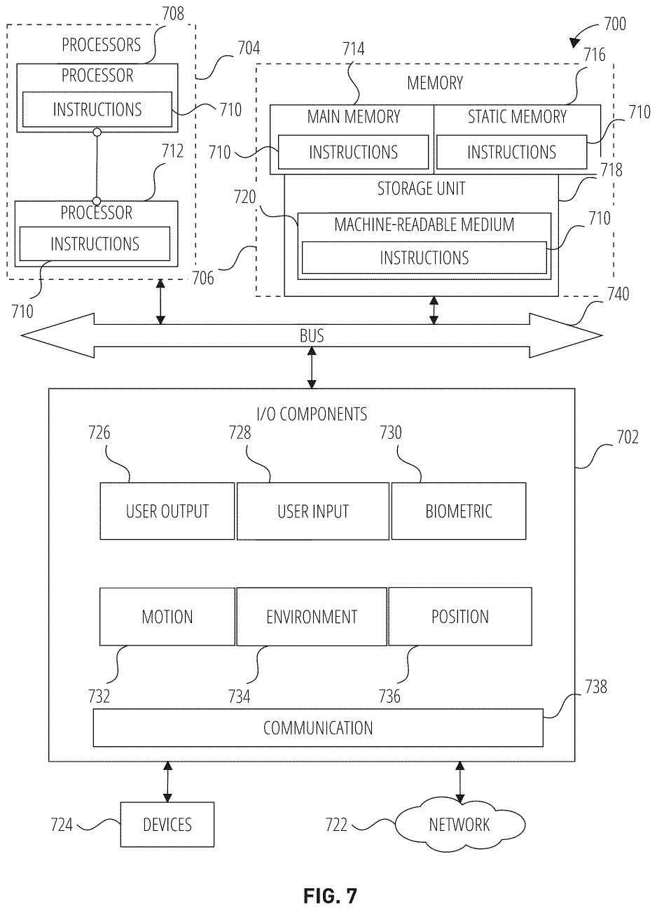

As used herein, a deployed software application can comprise a copy of a software application that is installed or operating on a machine (e.g., machine 700 of FIG. 7), such as a physical or virtual computing device (e.g., client device or a server), which provides one or more software features (e.g., that implement specific functionality or behavior at the machine) that are determined based on the software code of the software application. With respect to various example embodiments described herein, a deployed software application can comprise one or more software features (hereafter, AI-related software features) that facilitate use of, or are implemented using, an AI model, where the AI models can be running locally or remotely with respect to a machine operating (e.g., hosting) the deployed software application. For instance, an AI-related software feature can include a software feature that submits a prompt as input to a generative AI model, that receives output from the generative AI model in response to the submitted prompt, and that performs a specific function based on at least a portion of the received output (e.g., display the portion of the output in a graphical user interface generated by the machine).

As used herein, an entity can comprise a user, device, organization, or other actor that interacts with a software feature (e.g., AI-related software feature) of a deployed software application. For various example embodiments, an entity is characterized by a set of attribute values that determine what AI-related software configuration data (e.g., variation of configuration items included in the AI-related software configuration data) the entity at a remote device receives and how data items within the AI-related software configuration data for the entity's use case.

As used herein, an attribute value (of an attribute of an entity) provides contextual information associated with the entity associated with a request from a deployed software application for AI-related software configuration data. As described herein, an attribute value can be used to determine an appropriate subset of AI-related software configuration data items used to generate AI-related software configuration data, which is sent back in a response to a (requesting) deployed software application.

As used herein, tracking data can comprise one or more performance metrics or usage information collected from a deployed software application (e.g., an AI-related software feature of the deployed software application) that uses AI-related software configuration data. As described herein, tracking data can be used for monitoring, performance comparison, detecting regressions, or some combination thereof in association with AI-related software configuration data.

As used herein, AI-related software configuration data can comprise or describe information used to configure the operation of an AI model, such as a large language model (LLM) or other generative AI model. Examples of AI-related software configuration data Examples of AI-related software configuration data can include, without limitation, AI model information (e.g., AI model type, AI model version, etc.), one or more tuning parameters for an AI model (e.g., temperature, max tokens, input/output token costs), one or more prompts (e.g., including prompts generated based on prompt templates), model provider configurations, targeting rules for model distribution, fallback configurations, role-based access control settings, audit logging parameters, performance monitoring thresholds, regression detection parameters, and tracing configurations (e.g., for OpenLLMetry).

As used herein, an artificial intelligence (AI) model can comprise a computational framework, system, or algorithm configured to perform one or more tasks by learning from data (e.g., training data), including but not limited to classification, prediction, generation, recognition, or decision-making. AI models can include, by way of example and not limitation, machine learning (ML) models such as supervised learning models, unsupervised learning models, reinforcement learning models, and self-supervised learning models. AI model can also include specific architectures such as neural networks (e.g., convolutional neural networks, recurrent neural networks, transformer-based models), decision trees, support vector machines, or ensemble methods. An AI model can be trained using one or more datasets (e.g., training datasets) to infer patterns, relationships, or features, and can be executed on local or distributed computing infrastructure.

As used herein, a generative AI model can refer to any type of AI model that can create new content based on training data that the AI model trained on. For example, a generative AI model can produce text, images, video, audio, code, or synthetic data similar to the original data but not identical. Some that may be used in implementing a generative AI model can include Convolutional Neural Networks (CNNs), Recurrent Neural Networks (RNNs), Generative Adversarial Networks (GANs), Variational Autoencoders (VAEs), and Transformer models (which use attention mechanisms to learn the relationships between different parts of input data (such as words or pixels) and generate output data based on these relationships). A LLM is one type of generative AI model that usually comprises one or more transformer neural networks, which can be configured (e.g., trained) for general-purpose language generation or another language processing task. An LLM can be constructed using deep learning techniques, such as neural networks, and trained to understand, predict, and generate (as output data) language by learning patterns, semantics, syntax, and contextual meanings from input data. An LLM can operate by processing sequences of text and can perform various tasks, including text completion, translation, summarization, question answering, and dialogue generation, with the ability to generalize across languages and domains based on the scale of training data. Examples of LLMs can include, without limitation, a GPT model (e.g., GPT-4), a LLAMA model (e.g., LLAMA-2), a MISTRAL model, a Claude model (e.g., Claude 3), or a proprietary or tailored, generative pre-trained transformer.

As used herein, a software feature flag (or feature flag) can comprise a programmatic control mechanism in a software application that enables or disables specific functionality or behavior within software code (e.g., machine-readable instructions) of the software application without deploying new code. A feature flag can be implemented as a conditional statement, configuration value, or metadata that can be evaluated at runtime to determine whether a particular feature, capability, or logic path should be made available to a user, group of users, or environment. Feature flags can be dynamically updated via a flag delivery network or service, which can propagate feature flag values (or flag values) to software applications (e.g., client software application or software service) in real-time or near real-time. Feature flags can support targeting rules, percentage rollouts, user segmentation, or experimentation use cases such as A/B testing and phased rollouts. Feature flags can be stored, served, and evaluated locally or remotely, and may be managed through a centralized platform or distributed delivery system.

As used herein, a flag delivery network (or service) can comprise a network of computing devices and network components that enable the distribution and management of software configuration data, such a (software) feature flag as AI-related software configuration data. The flag delivery network can deliver configuration data low latency and large scale (e.g., global) availability through one or more resilient layers, which can include: a multi-availability zone core architecture for primary configuration storage and processing; a distributed content delivery network (CDN) for rapid access; optional relay proxies for local configuration availability; software development kits (SDKs) (e.g., self-recovering SDKs that maintain connection stability); in-memory caching mechanisms for performance optimization; and one or more fallback configuration values stored in application code to ensure continuous operation during network disruptions. A flag delivery network can implement synchronous data communication, asynchronous data communication, or both through streaming connections that enable real-time propagation of configuration updates (e.g., run-time configuration updates) without requiring software application redeployment, while maintaining controls such as audit logging, role-based access control, or change approval workflows.

Reference will now be made in detail to various example embodiments of the present disclosure, examples of which are illustrated in the appended drawings. The present disclosure may, however, be embodied in many different forms and should not be construed as being limited to the examples set forth herein. To avoid obscuring the inventive subject matter with unnecessary detail, various functional components (e.g., modules, mechanisms, devices, nodes, etc.) that are not germane to conveying an understanding of the inventive subject matter have been omitted from figures. It will be readily understood that various additional components may be supported by various example embodiments to facilitate additional functionality that is not specifically described herein.

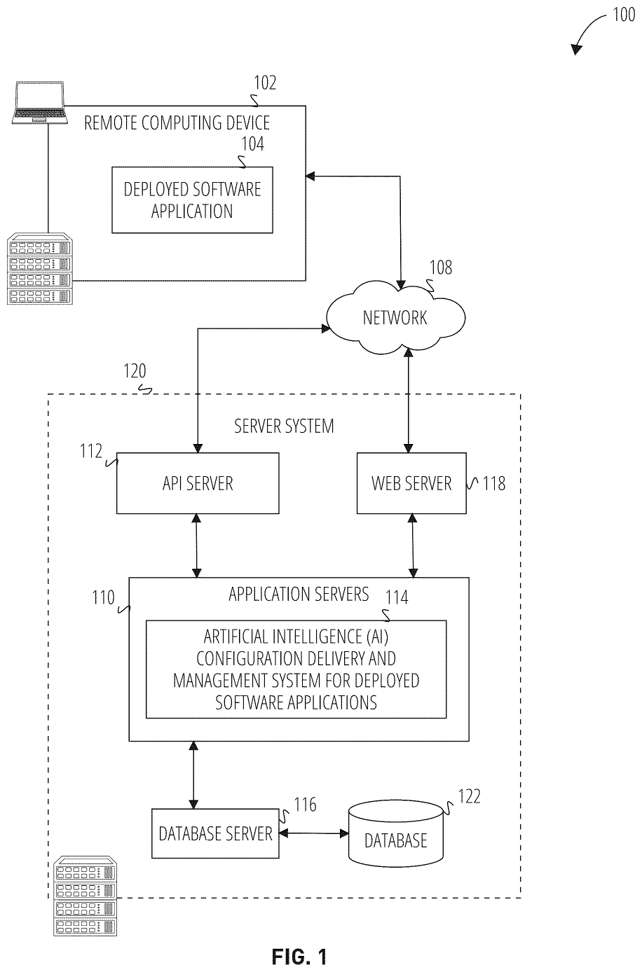

FIG. 1 is a diagrammatic representation of an example AI configuration delivery and management system 114 for deployed software applications in a networked environment 100 in which the present disclosure may be deployed, in accordance with some example embodiments of the present disclosure. Though not shown, the AI configuration delivery and management system 114 can include one or more instances of a remote computing device 102, such as one or more client devices or one or more servers that are external to the server system 120.

Remote computing device 102 can be associated with an entity, such as user, organization, or an underlying computing device. Remote computing devices 102 can host a number of software applications, including a deployed software application 104, which represents an instance (e.g., copy) of a deployed software application operating on the remote computing device 102 (e.g., in connection with a specific entity, such a specific user or organization). One or more other remote computing devices (not shown) can also be operating their own instance (e.g., copy) of the same deployed software application, where those instances can be operating in connection with a same or different entity as deployed software application 104 operating on remote computing device 102. Deployed software application 104 can be communicatively coupled with a server system 120 via a network 108 (e.g., communication network or the Internet). For various example embodiments, deployed software application 104 communicates with one or more components of the server system 120, such as AI configuration delivery and management system 114, by way of one or more software libraries, such as those provided by a Software Development Kit (SDK), which can provide one or more Applications Program Interfaces (APIs). Deployed software application 104 can also communicate with locally-hosted applications on the remote computing device 102 using APIs.

Deployed software application 104 is able to communicate and exchange data with the server system 120 via the network 108. The data exchanged between the deployed software application 104 and the server system 120 can include, without limitation, one or more functions (e.g., commands to invoke functions), one or more requests with payload data (e.g., configuration key, context data, fallback parameters, values for user-defined variables), and one or more responses with payload data (e.g., AI-related software configuration data generated by the AI configuration delivery and management system 114).

The server system 120 supports various services and operations that are provided to the deployed software application 104. Such operations include access to the functionalities of the systems in server system 120, such as those provided by AI configuration delivery and management system 114.

Server system 120 provides server-side functionality via the network 108 to the deployed software application 104. While certain functions of the networked environment 100 are described herein as being performed by either the deployed software application 104 or by the server system 120, the location of certain functionality either within the deployed software application 104 or the server system 120 may be a design choice. For example, it may be technically preferable to initially deploy certain technology and functionality within the server system 120 but to later migrate this technology and functionality to the deployed software application 104 where a remote computing device 102 has sufficient processing capacity.

Turning now specifically to the server system 120, an Application Program Interface (API) server 112 is coupled to, and provides a programmatic interface to, application servers 110. The application servers 110 are communicatively coupled to a database server 116, which facilitates access to a database 122 that stores data associated with (e.g., generated or used by) the AI configuration delivery and management system 114, the remote computing device 102, or some combination thereof. Similarly, a web server 118 is coupled to the application servers 110, and provides web-based interfaces to the application servers 110. To this end, the web server 118 processes incoming network requests over the Hypertext Transfer Protocol (HTTP) and several other related protocols.

The Application Program Interface (API) server 112 receives and transmits data between the remote computing device 102 and the application servers 110. Specifically, the Application Program Interface (API) server 112 provides a set of interfaces (e.g., routines and protocols) that can be called or queried by the deployed software application 104 in order to invoke functionality of the application servers 110, such as sending a request for AI configuration information for an AI-related software feature of the deployed software application and receiving a response containing the AI configuration information. The Application Program Interface (API) server 112 exposes to the deployed software application 104 various functions supported by the application servers 110, including servicing a request for AI configuration information for an AI-related software feature of the deployed software application, or controlling/managing operation of the AI configuration delivery and management system 114 (e.g., via graphical user interface provided to a client device by the AI configuration delivery and management system 114).

The application servers 110 host a number of server applications and subsystems, including for example an AI configuration delivery and management system 114. The AI configuration delivery and management system 114 implements functions and operations for delivering and remotely managing AI-related software configuration data with respect to one or more deployed software applications on one or more remote computing devices (e.g., 102).

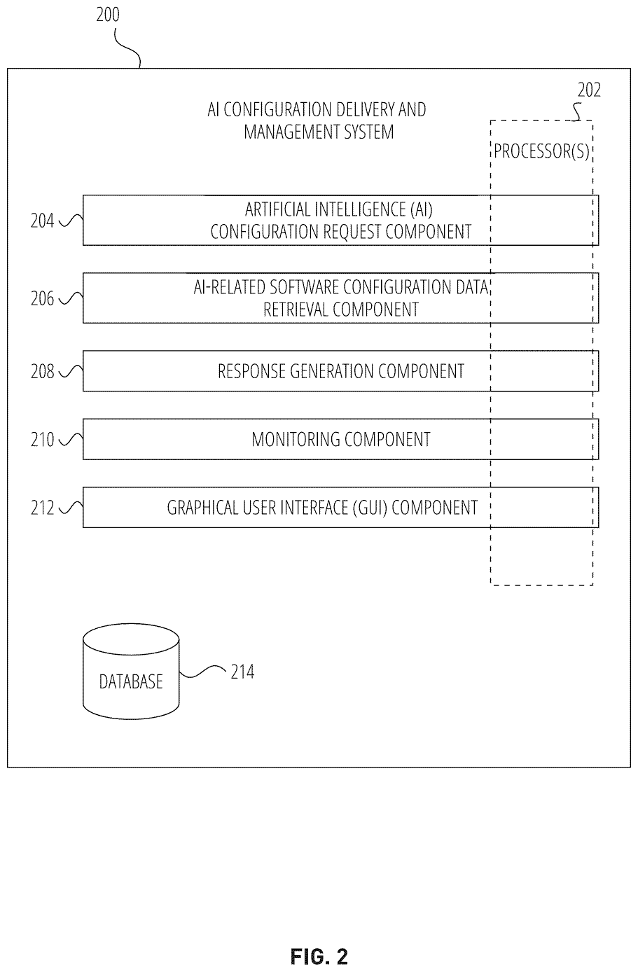

FIG. 2 is a block diagram illustrating an example implementation of an AI configuration delivery and management system 200, in accordance with some example embodiments of the present disclosure. For some example embodiments, the anomaly detection system 200 represents an example of the AI configuration delivery and management system 114 described with respect to FIG. 1. As shown, the AI configuration delivery and management system 200 comprises an AI configuration request component 204, an AI-related software configuration data retrieval component 206, a response generation component 208, a monitoring component 210, and a graphical user interface component 212. According to various example embodiments, one or more of the AI configuration request component 204, the AI-related software configuration data retrieval component 206, the response generation component 208, the monitoring component 210, and the graphical user interface component 212 are implemented by one or more processors 202. Data generated by, or used by, one or more of the AI configuration request component 204, the AI-related software configuration data retrieval component 206, the response generation component 208, the monitoring component 210, and the graphical user interface component 212 is stored on a database (or datastore) 214 of the AI configuration delivery and management system 200.

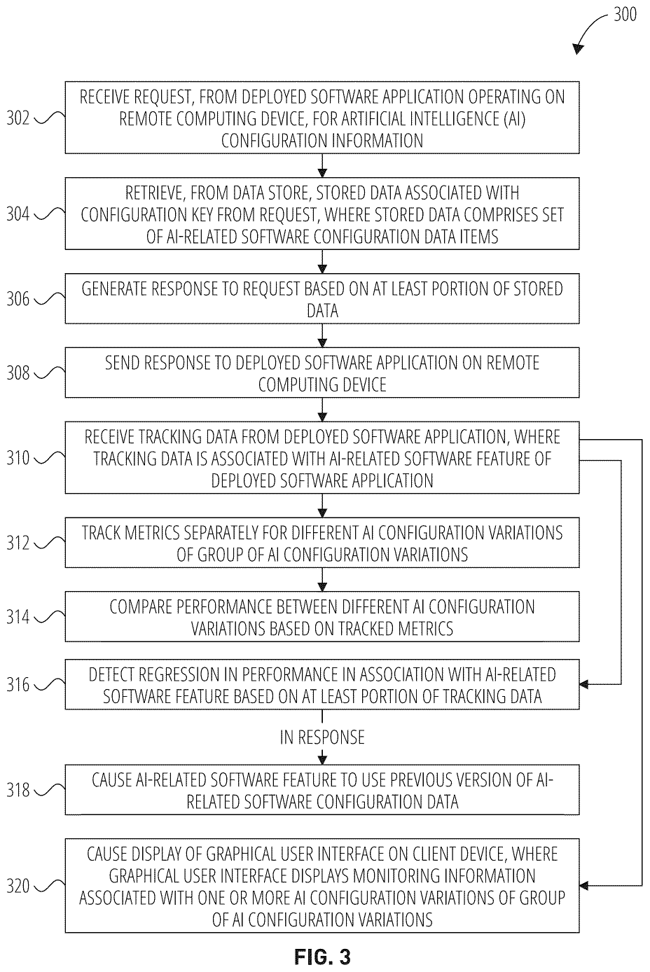

The AI configuration request component 204 enables or facilitates the receiving of a request, from a deployed software application (e.g., instance or copy of the deployed software application) operating on a remote computing device, for AI configuration information. The AI-related software configuration data retrieval component 206 enables or facilitates retrieval of stored data associated with a configuration key provided by the request, where the stored data can be retrieved from a data store such as databases 214. The response generation component 208 enables or facilitates generation of a response to the request based on at least a portion of the stored data, where the response comprises AI-related software configuration data generated specific to the request. The response generation component 208 also enables or facilitates the sending of the response to the deployed software application. The monitoring component 210 enables or facilitates the receiving of tracking data from a deployed software application (e.g., instances of the same deployed software application on different remote computing devices), the tracking of metrics in association with different AI configuration variations, and the monitoring of the tracked metrics. More regarding operation of the AI configuration delivery and management system 200 and its various components is described with respect to method 300 of FIG. 3.

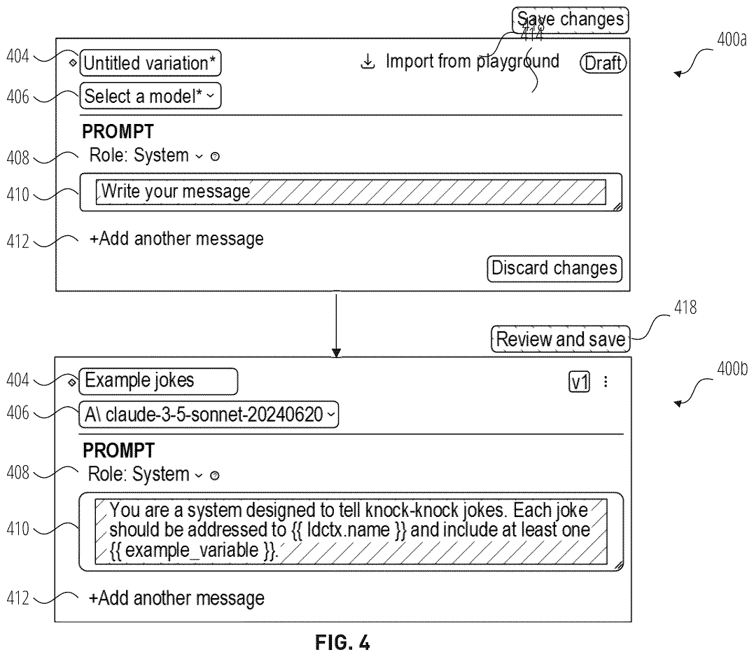

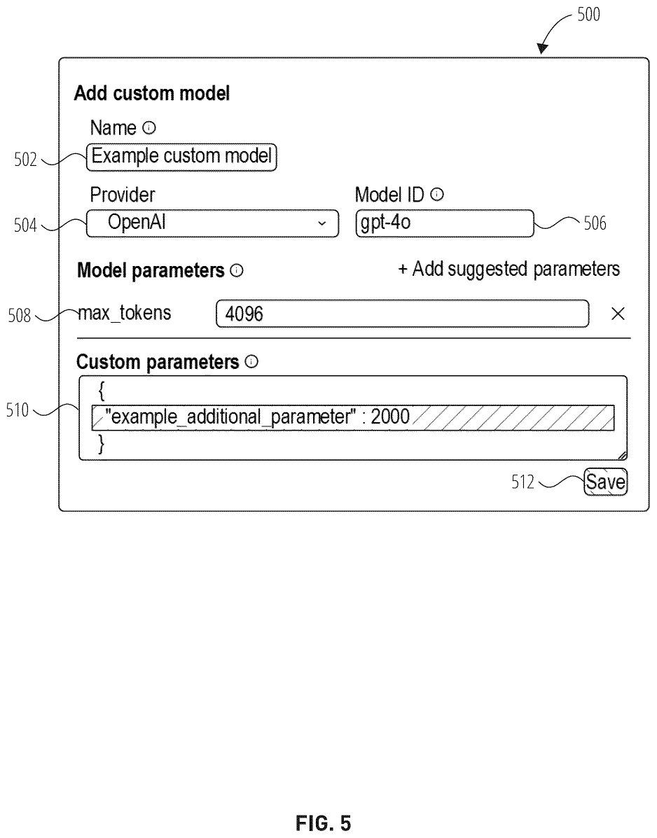

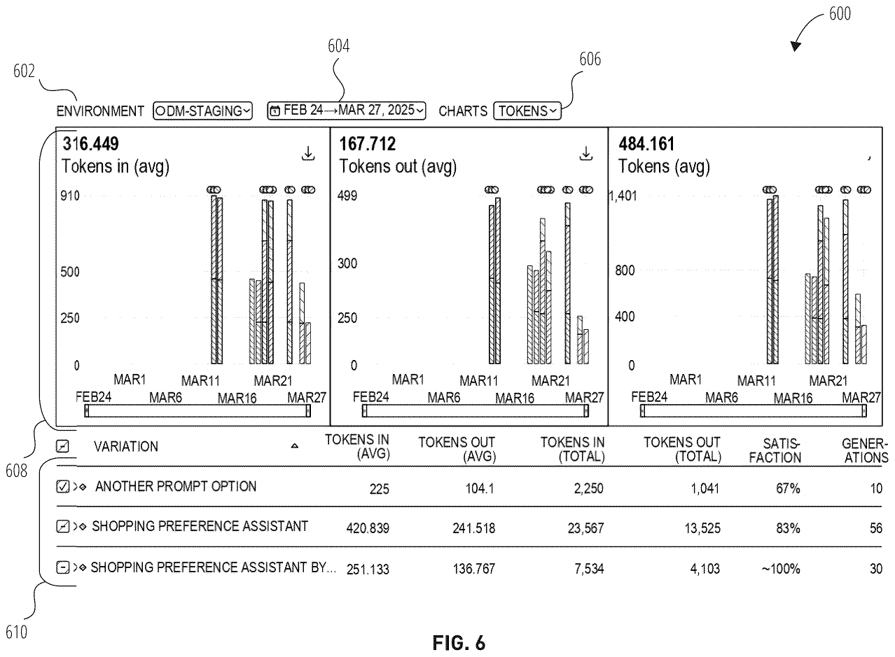

The graphical user interface component 212 is configured to generate (or support generation of) various graphical user interfaces that can be displayed on a client device (e.g., computing device external to the server system 120) and that enable a user, such as an administrative user or a developer, of the AI configuration delivery and management system 200 to perform one or more of the following: create, modify, or delete one or more AI-related software configuration data items; create, modify, or delete one or more groupings of one or more AI-related software configuration data items (e.g., each grouping associated being associated with a different key, such as a configuration key); create, modify, or delete one or more target rules; and configure and manage performance tracking or monitoring of deployed software application (e.g., AI-related software feature of the deployed software application) that operate based on AI-related software configuration data provided by the AI configuration delivery and management system 200. Examples of the graphical user interfaces include, without limitation, those illustrated by FIG. 4, FIG. 5, and FIG. 6.

FIG. 3 is a flowchart illustrating an example method 300 for delivering and remotely managing AI-related software configuration data with respect to one or more deployed software applications on one or more remote computing devices, in accordance with some example embodiments of the present disclosure. According to various example embodiments, AI-related software configuration data delivered (e.g., provided) to a deployed software application on a remote computing device can be used by an AI-related software feature of the deployed software application to operate (e.g., the AI-related software feature can provide a functionality using an AI model according to the AI-related software configuration data). It will be understood that example methods described herein can be performed by a machine, such as machine 700 of FIG. 7, in accordance with some embodiments. For example, the method 300 can be performed by the AI-related AI configuration delivery and management system 114 described with respect to FIG. 1, the AI configuration delivery and management system 200 described with respect to FIG. 2, or individual components thereof. An operation of various methods described herein can be performed by one or more hardware processors (e.g., central processing units or graphics processing units) of a computing device (e.g., a desktop, server, laptop, mobile phone, tablet, etc.), which can be part of a computing system based on a cloud architecture. Example methods described herein can also be implemented in the form of executable instructions stored on a machine-readable medium or in the form of electronic circuitry. For instance, the operations of method 300 can be represented by executable instructions that, when executed by a processor of a computing device, cause the computing device to perform the method 300. Depending on the embodiment, an operation of an example method described herein can be repeated in different ways or involve intervening operations not shown. Though the operations of example methods can be depicted and described in a certain order, the order in which the operations are performed can vary among embodiments, including performing certain operations in parallel.

At operation 302, a processor (e.g., one or more processors 202 implementing AI configuration request component 204) receives a request, from a deployed software application operating on a remote computing device, for artificial intelligence (AI) configuration information. According to various example embodiments, the request comprises a configuration key that identifies a group of different AI configuration variations. As described herein, the group of different AI configuration variations can be stored or otherwise organized as part of an AI configuration resource object, where the AI configuration resource object is associated with (e.g., identified by) the configuration key, and where the AI configuration resource object can also include one or more target rules that are eventually used to determine (e.g., identify) the AI configuration variation (e.g., subset of AI-related software configuration data items) to be used to generate a response to the request. For some example embodiments, the request includes context data that comprises a set of attribute values associated with an entity of the deployed software application. Depending on the example embodiment, the entity can represent a user that is using the deployed software application, an organization that is using the deployed software application, the remote computing device operating (e.g., hosting) the deployed software application, or another identifiable entity associated with the deployed software application. The configuration key serves as an identifier that enables the system to retrieve the appropriate AI-related software configuration data for the requesting application.

During operation 304, the processor (e.g., one or more processors 202 implementing the AI-related software configuration data retrieval component 206) retrieves, from a data store, stored data associated with the configuration key from the request, where the stored data comprises a set of AI-related software configuration data items. For various example embodiments, the data store is implemented as database 122 shown in FIG. 1 or database 214 shown in FIG. 2. Depending on the example embodiment, the set of AI-related software configuration data items comprises various types of configuration information to be used by the AI-related software feature, such as AI model information, one or more AI model parameters, one or more prompts (e.g., messages) for generative AI models, or one or more feature flags. Additionally, for some example embodiments, the stored data comprises a set of target rules that can be evaluated based on the attribute values from the request. As described herein, the set of target rules can enable the processor to dynamically determine which specific AI-related software configuration data items should be returned based on contextual information (e.g., attribute values of entity) provided in the request. For example, target rules can include conditions based on entity attribute values (e.g., serving different AI models to premium versus free users), geographical location (e.g., providing region-specific prompt templates), device characteristics (e.g., optimizing model parameters for different remote computing device capabilities), or entity's organization membership (e.g., delivering enterprise-specific AI configurations). Depending on the example embodiment, a target rule can be structured as conditional statements that, when evaluated against one or more attribute values from the context data, determine which subset of the AI-related software configuration data items should be used in generating the select AI-related software configuration data of the response. More complex target rules can also include logical combinations of multiple attribute conditions, allow percentage-based rollouts of new or different AI configuration variations, or implement fallback behavior when a primary configuration variation is unavailable. Target rules from the set of target rules can be evaluated according to an order (e.g., according to priority or a sequence). Where no target rules are found to apply to the one or more attribute values, the processor can apply or use a default target rule to determine the subset of AI-related software configuration data items to be used to generate a response.

At operation 306, the processor (e.g., one or more processors 202 implementing the response generation component 208) generates a response to the request based on at least a portion of the stored data. According to various example embodiments, generating the response comprises determining, based on one or more attribute values from the set of attribute values in the request, a subset of AI-related software configuration data items from the set of AI-related software configuration data items (provided by the retrieved stored data). This subset can correspond to an individual (e.g., single) AI configuration variation of the group of different AI configuration variations (e.g., AI configuration resource object) identified by the configuration key. For some example embodiments, the generation process comprises evaluating a subset of target rules (of the set of target rules from the retrieved stored data) based on the one or more attribute values to identify the appropriate subset of AI-related software configuration data items from the set of AI-related software configuration data items (from the retrieved stored data). Depending on the example embodiment, if an individual AI-related software configuration data item in the subset of AI-related software configuration data items comprise a data item template, such as a prompt template, the processor can generate a new data item (e.g., new prompt for a generative AI model) based on the data item template, which can involve replacing one or more references to variables or attributes in the data item template with appropriate values (e.g., user-defined variable values or attribute values from the request context data).

With respect to a template such as a prompt template, when using a template to customize a data item generated, the syntax defining the template can references to variables (e.g., indicated with double curly braces, such as {{example_variable}}) that are replaced with variable values provided (e.g., in the request), or references to (context) attributes (e.g., indicated with the ldctx prefix and dot notation, such as {{ldctx.name}} or {{ldctx.address.city}}) that are replaced with the corresponding attribute values from the context data in the request. Table 2 below provides an example definition of a prompt template for a prompt having a “system” role.

TABLE 2

{ ″role″: ″system″,
″content″: ″You are an AI assistant for {{
ldctx.organization_name }}, specialized in answering
questions about {{ product type }}. When responding to
customers, always address them by name: {{ ldctx.user.name
}}. If the customer has a {{ ldctx.subscription_tier } }
subscription, provide more detailed responses including
technical specifications. Keep your tone {{ tone_preference
}} and ensure all answers comply with { {
ldctx.organization_name } }'s communication guidelines. If you
don't know an answer, direct the customer to contact support
at { { ldctx.support_email } } . ″
}

With respect to prompts, a system described herein can use role designations in association with prompts (or prompt templates used to generate prompts), where roles serve as critical semantic designators that orchestrate multi-prompt interactions within the AI-related software feature. Each role, such as “system,” “user,” or “assistant,” can define a prompt's function with respect to a generative AI model and expected behavior within a larger AI interaction framework. These roles can establish a contextual framework for interpretation, allowing the generative AI model to properly situate each prompt within its intended functional domain and maintain appropriate behavioral boundaries during execution. The role designations can also facilitate complex conversation modeling by enabling separation of concerns across multiple prompts, with each prompt processed according to an established role-specific protocol. Through this hierarchical arrangement of roles, the system can achieve more sophisticated control over AI behavior than would be possible with undifferentiated prompts, while ensuring consistency across different AI configuration variations even when prompt content differs.

For operation 308, the processor (e.g., one or more processors 202 implementing the response generation component 208) sends the response to the deployed software application on the remote computing device. For various example embodiments, the response is sent via a flag delivery network to the deployed software application. The response can enable an AI-related software feature of the deployed software application to operate based on the select AI-related software configuration data (e.g., using one or more AI-related software configuration data items of the select AI-related software configuration data) contained in the response. Depending on the example embodiment, the AI-related software configuration data can comprise AI model information, parameters for an AI model, or a set of prompts for a generative AI model that the AI-related software feature will use to provide its functionality.

According to various example embodiments, the deployed software application facilitates the initial request (received at operation 302) through integration with a software library, such as a Software Development Kit (SDK), which can be specific to AI configuration delivery and management. For example, an SDK can provide one or more functions that enable the deployed software application to request AI-related configuration information by making one or more function calls that include a configuration key, context data (e.g., context information), one or more fallback parameters, one or more user-defined variables, or some combination thereof. The SDK can establish communication between the remote computing device and a system (e.g., AI configuration delivery and management system 114 or AI configuration delivery and management system 200) over a data delivery network (e.g., a flag delivery network), where the SDK can handle the transmission details and authentication. Once the response containing the select AI-related software configuration data is received through the SDK, the application code of the deployed software application can integrate configuration information from the response by accessing one or more properties and methods provided by the SDK's response object. For instance, the deployed software application can access model information from the response using one or more attribute accessors, using one or more parameters through structured property interfaces, or implementing prompts via methods provided by the SDK. An example of using a SDK for making a request can include a function call such as aiClient.config(“ai-config-key-123abc”, context, fallbackConfig, variables), where configuration key can identify the requested AI configuration, context (e.g., representing a context object) contains one or more attribute values about a requesting entity, fallbackConfig can define a default behavior if retrieval of AI configuration information in association with the configuration key fails, and one or more variables can provide custom values to substitute in data items generated by data item templates (e.g., substitute in a prompt generated based on a prompt template as described herein). The deployed software application can then process this response object received from the system (e.g., AI configuration delivery and management system 114 or AI configuration delivery and management system 200), extract desired configuration information from the response object, and use (e.g., apply) the extracted information within the deployed software application's AI-related software feature, ensuring that the AI functionality of the AI-related software feature operates according to the configuration information received from the system.

At operation 310, the processor (e.g., one or more processors 202 implementing the monitoring component 210) receives tracking data from the deployed software application, where the tracking data is associated with the AI-related software feature of the deployed software application. Depending on the example embodiment, this tracking data can provide performance metrics and usage information (e.g., associated with the deployed software application or the AI-related software feature specifically) that allows a system (e.g., AI configuration delivery and management system 114 or AI configuration delivery and management system 200) to monitor how the AI-related software feature is performing with the provided AI-related software configuration data (e.g., provided in the last response to the deployed software application). For some example embodiments, the tracking data comprises one or more various metrics, such as duration metrics, token usage metrics, generation success metrics, generation error metrics, time to first token metrics, output satisfaction metrics, and the like. Depending on the example embodiment, the processor can correlate the tracking data with logs, experiments, or testing (e.g., internal testing or A/B testing) being conducted with respect to the AI-related software feature and one or more AI configuration variations from the group of different AI configuration variations associated with the configuration key. After operation 310, method 300 can proceed to operation 312, operation 316, or operation 320.

During operation 312, the processor (e.g., one or more processors 202 implementing the monitoring component 210) tracks metrics separately for different AI configuration variations of the group of AI configuration variations. Depending on the example embodiment, operation 312 can comprise maintaining separate performance records for each AI configuration variation, thereby allowing for granular analysis of how changes to specific configuration elements can affect overall performance. According to some example embodiments, operation 312 comprises updating at least one tracked metric based on metrics contained in the tracking data received from the deployed software application. The separate tracking enables the system to compare and identify which specific configuration variations perform better or worse than others.

After operation 312, at operation 314, the processor (e.g., one or more processors 202 implementing the monitoring component 210) compares performance between different AI configuration variations based on the tracked metrics. For various example embodiments, this comparison provides insights into which configuration variations deliver optimal performance across different metrics. Depending on the example embodiment, the comparison can examine metrics across different dimensions, such as efficiency, accuracy, user satisfaction, or resource utilization. This performance comparison supports data-driven decision making about which configuration variations should be maintained, modified, or deprecated.

For operation 316, the processor (e.g., one or more processors 202 implementing the monitoring component 210) detects regression in performance in association with the AI-related software feature based on at least a portion of the tracking data. In particular, the regression in performance can be in association with the AI-related software feature while its operating based on the select AI-related software configuration data provided during operation 308. Depending on the example embodiment, a regression can be identified when current performance metrics fall below one or more historical baselines or expected thresholds. A system can employ statistical models to identify significant performance degradations that warrant intervention. Depending on the example embodiment, different types of regressions can be monitored, such as increased error rates, longer processing times, higher resource consumption, or decreased user satisfaction.

In response to detecting the regression in performance during operation 316, at operation 318, the processor (e.g., one or more processors 202 implementing the monitoring component 210) causes the AI-related software feature to use a previous version of the AI-related software configuration data. For various example embodiments, operation 316 comprises the processor sending a request to the deployed software application that causes the deployed software application to fallback to using a previous version of the AI-related software configuration data, which can cached or backed-up locally by the deployed software application or provided to the deployed software application (e.g., in the request) by the system. The automatic fallback mechanism provided by various example embodiments can ensure that end users are not negatively impacted by underperforming AI configuration variations. According to some example embodiments, the system maintains one or more historical versions of AI-related software configuration data to facilitate rapid rollback when performance issues are detected. This capability can provide a safety net that allows for experimentation with new AI configuration variations while minimizing risk to deployed software applications.

At operation 320, the processor (e.g., one or more processors 202 implementing the graphical user interface component 212) causes display of a graphical user interface on a client device, where the graphical user interface displays monitoring information associated with one or more AI configuration variations of the group of AI configuration variations. According to various example embodiments, the monitoring information is generated based on at least a portion of the tracking data received from deployed software applications. As shown in graphical user interface 600 of FIG. 6, the graphical user interface can present visualizations of performance metrics, comparative analyses between different AI configuration variations, historical trends, alerts for detected regressions, or some combination thereof. Depending on the example embodiment, the graphical user interface can allow a user (e.g., administrative user or developer) to drill down into specific metrics, filter data by time periods, or export analytics for further analysis, thereby enabling the user (or their team) to make informed decisions about AI configuration management.

FIG. 4 through FIG. 6 illustrate example graphical user interfaces 400a, 400b, 500, 600 that can be used by a user to configure and manage AI configuration delivery, in accordance with some example embodiments of the present disclosure. In particular, graphical user interfaces 400a, 400b of FIG. 4 can be used by a user to define an AI configuration variation that includes one or more prompts or prompt templates. Graphical user interface 500 can be used by a user to a specific AI model and one or more one or more AI model parameters for the specific AI model, which can then be selected for use with one or more AI configuration variations (e.g., associated with an AI configuration resource object). Graphical user interface 600 can be used by a user to monitor, compare, and analyze performance of different AI configuration variations (e.g., in association with a particular AI configuration resource object).

Referring now to FIG. 4, the graphical user interface 400a comprises a graphical user interface for creating and managing AI configuration variations. The graphical user interface 400a includes an AI configuration variation name field 404, an AI model selection field 406, a role designation field 408, a prompt field 410, an add prompt button 412, a data import button 414, and a save button 418. The graphical user interface 400a represents an initial state of the interface before a user (e.g., an administrative user) has populated configuration information.

The AI configuration variation name field 404 allows users to provide a human-readable identifier for the AI configuration variation being created or edited. The AI model selection field 406 enables users to select, from a list of available AI models, an AI model that will be used with this AI configuration variation. The role designation field 408 allows users to specify the role of the prompt within the AI system, such as “system,” which defines the overall behavior instructions for the AI model. The prompt field 410 provides an area where users can enter prompt content that will be sent to the AI model, which may include template variables for runtime customization. The add prompt button 412 enables users to add additional prompts to the AI configuration variation (e.g., for more complex interactions). The data import button 414 provides functionality to import AI configuration information settings (e.g., other prompts) from an external data source, such as a playground environment. The save button 418 allows users to save their configuration changes. Through the graphical user interface 400a, a user can create and manage AI configurations that determine how an AI-related software feature of a deployed software application behaves without requiring code changes to those applications, thereby enabling dynamic control over AI behavior based on different contexts and use cases.

Graphical user interface 400b illustrates the same interface after a user has populated information, showing a completed AI configuration variation. In this populated state, the AI configuration variation name field 404 has been set to “Example jokes”, the AI model selection field 406 displays the selected model “claude-3-5-sonnet-20240620”, and the prompt field 410 contains specific instructions for the AI model with template variables: “You are a system designed to tell knock-knock jokes. Each joke should be addressed to {{ldctx.name}} and include at least one {{example_variable}}.” As described herein, these template variables can allow for customization of the prompt provided to a deployed software application (e.g., customization based on context information from a request), where “{{ldctx.name}}” can be replaced with an attribute value from the requesting entity, and where “{{example_variable}}” can be replaced with a custom variable value (e.g., provided via the request).

Referring now to FIG. 5, the graphical user interface 500 illustrates an interface for adding and configuring a custom AI model within an AI configuration management system. The graphical user interface 500 comprises an AI model name field 502, a model provider field 504, a model version field 506, a model parameter field 508, a custom parameter field 510, and a save button 512. This interface enables users to create and manage AI model configurations that can be used in AI Configs for deployed software applications.

The AI model name field 502 allows users to enter a descriptive name for their AI model configuration, shown in the example as “Example custom model.” This name appears in model selection dropdowns when creating AI configuration variations for a given AI configuration resource object and is used for reference when managing model configurations.

The model provider field 504 contains a dropdown selector where users can specify the provider of the AI model, with “OpenAI” selected in this example. This field identifies the source of the AI model that will be configured via graphical user interface 500.

The model version field 506 displays “gpt-40” in this example, representing the specific model identifier used by the provider. The value in this field can correspond to an exact identifier that the AI model provider uses for the selected AI model.

The model parameter field 508 shows a configurable AI model parameter “max_tokens” with a value of “4096” and includes an option to remove this parameter. This section allows users to configure standard operating parameters for the AI model that will become default values when this AI model is selected for use in an AI configuration variation.

The custom parameter field 510 allows users to define additional configuration parameters beyond the standard ones. In this example, a user enters a JSON object with a single custom parameter “example_additional_parameter”: 2000. This section enables advanced customization of AI model behavior through provider-specific parameters.

The save button 512 allows users to store the custom model configuration in the system, making it available for use in AI Config variations throughout the application.

Referring now to FIG. 6, the graphical user interface 600 comprises an environment selection field 602, a date range field 604, a metric selection field 606, a monitoring visual 608, and an AI configuration variation selection 610. The graphical user interface 600 represents a monitoring dashboard for tracking performance metrics of AI configuration variations used by deployed software applications.

The environment selection field 602 allows users to select the specific environment for which they want to view monitoring data, with “DM-Staging” shown as the selected environment in the example. This selection ensures performance metrics are specific to the chosen environment. Adjacent to this is the date range field 604 displaying “Feb. 24→Mar. 27, 2025,” which enables users to specify the time period for which monitoring data should be displayed.

The metric selection field 606, with “Tokens” selected, provides users the ability to choose which set of performance metrics to view, with token usage being displayed in the current view. Below these controls, the monitoring visual 608 presents a series of graphs visualizing token usage metrics over time. The graphs display three metrics: average tokens in (showing 316.449), average tokens out (showing 167.712), and average total tokens (showing 484.161). Each graph includes trend lines representing different AI configuration variations, allowing for visual comparison of performance across variations over the selected time period.

At the bottom of the interface, the AI configuration variation selection 610 displays a detailed table of metrics for each variation. The table includes columns for various performance indicators, including average tokens in, average tokens out, total tokens in, total tokens out, satisfaction percentage, and generation counts. Three different AI configuration variations are shown: “Another prompt option” having 67% satisfaction, “Shopping preference assistant” with 83% satisfaction, and “Shopping preference assistant by . . . ” with approximately 100% satisfaction. This tabular view enables users to compare performance metrics across different AI configuration variations at a glance.

The graphical user interface 600 provides a comprehensive monitoring solution for AI configurations, enabling users to track various performance metrics, compare different AI configuration variations, identify trends over time, and make data-driven decisions about which AI configuration variations deliver optimal performance. This monitoring capability can help a user detect and address performance issues, validate the effectiveness of different AI configuration approaches, and continuously optimize AI-related software features in deployed software applications.

In some examples, components in the networked environment 100 can be a machine 700 as shown in FIG. 7. FIG. 7 is a diagrammatic representation of the machine 700 within which instructions 710 (e.g., software, a program, an application, an applet, an application, or other executable code) for causing the machine 700 to perform any one or more of the methodologies discussed herein may be executed. For example, the instructions 710 may cause the machine 700 to execute any one or more of the methods described herein. The instructions 710 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines that individually or jointly execute the instructions 710 to perform any one or more of the methodologies discussed herein. The machine 700, for example, may comprise the remote computing device 102 or any one of a number of server devices forming part of the AI configuration delivery and management system 114. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 702, which may be configured to communicate with each other via a bus 740. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 714, the static memory 716, and storage unit 718 store the instructions 710 embodying any one or more of the methodologies or functions described herein. The instructions 710 may also reside, completely or partially, within the main memory 714, within the static memory 716, within machine-readable medium 720 within the storage unit 718, within at least one of the processors 704 (e.g., within the processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones may include a touch input device or other such input mechanisms, while a headless server machine will likely not include such a touch input device. It will be appreciated that the I/O components 702 may include many other components that are not shown in FIG. 7. In various examples, the I/O components 702 may include user output components 726 and user input components 728. The user output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 732 include acceleration sensor components (e.g., accelerometer), gravitation sensor components, rotation sensor components (e.g., gyroscope).

The environmental components 734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the remote computing device 102 may have a camera system comprising, for example, front cameras on a front surface of the remote computing device 102 and rear cameras on a rear surface of the remote computing device 102. The front cameras may, for example, be used to capture still images and video of a user of the remote computing device 102 (e.g., “selfies”). The rear cameras may, for example, be used to capture still images and videos in a more traditional camera mode. In addition to front and rear cameras, the remote computing device 102 may also include a 360° camera for capturing 360° photographs and videos.

Further, the camera system of a remote computing device 102 may include dual rear cameras (e.g., a primary camera as well as a depth-sensing camera), or even triple, quad or penta rear camera configurations on the front and rear sides of the remote computing device 102. These multiple cameras systems may include a wide camera, an ultra-wide camera, a telephoto camera, a macro camera and a depth sensor, for example.

The position components 736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the machine 700 to a network 722 or devices 724 via respective coupling or connections. For example, the communication components 738 may include a network interface component or another suitable device to interface with the network 722. In further examples, the communication components 738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, location via detecting an NFC beacon signal that may indicate a particular location, and so forth.

The various memories (e.g., main memory 714, static memory 716, and memory of the processors 704) and storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

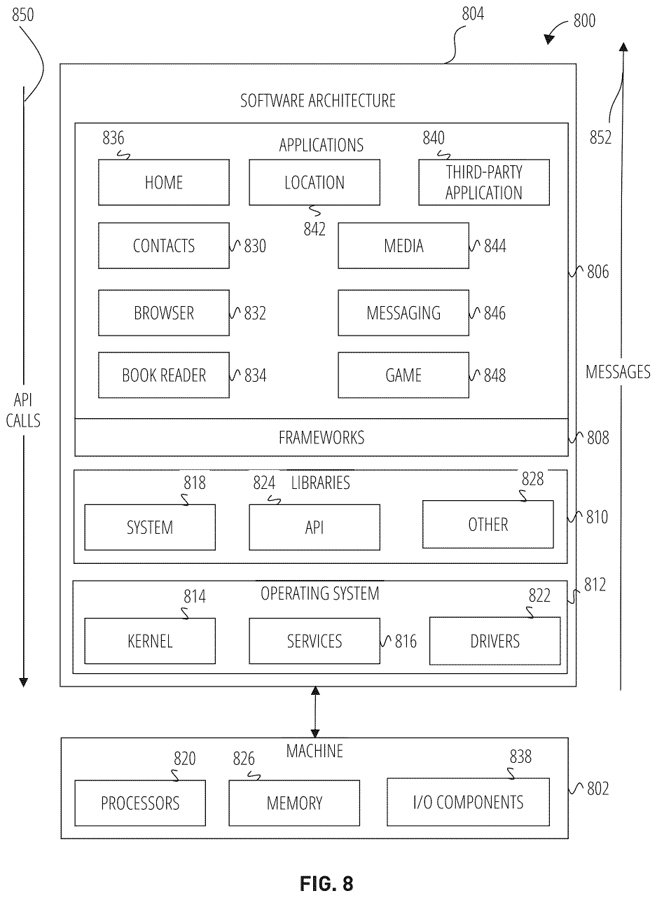

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionalities. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 810 provide a common low-level infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 810 can also include a wide variety of other libraries 828 to provide many other APIs to the applications 806.

The frameworks 808 provide a common high-level infrastructure that is used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

Described implementations of the subject matter can include one or more features, alone or in combination as illustrated below by way of examples.
Example 1 is a system comprising: a processor; and a memory storing instructions that, when executed by the processor, cause the system to perform operations comprising: receiving a request, from a deployed software application operating on a remote computing device, for AI configuration information, the request comprising a configuration key that identifies a group of different AI configuration variations, the request comprising context data that comprises a set of attribute values associated with an entity of the deployed software application; retrieving, from a data store, stored data associated with the configuration key, the stored data comprising a set of AI-related software configuration data items; generating a response to the request based on at least a portion of the stored data, the response comprising select AI-related software configuration data, the generating of the response comprising: determining, based on one or more attribute values from the set of attribute values, a subset of the set of AI-related software configuration data items, the subset of AI-related software configuration data corresponding to an individual AI configuration variation of the group of different AI configuration variations; and generating the select AI-related software configuration data based on the subset of AI-related software configuration data items; and sending the response to the deployed software application on the remote computing device, an AI-related software feature of the deployed software application operating based on the select AI-related software configuration data from the received response.
In Example 2, the subject matter of Example 1 includes, wherein the select AI-related software configuration data comprises AI model information for an AI model used by the AI-related software feature.
In Example 3, the subject matter of Examples 1-2 includes, wherein the select AI-related software configuration data comprises one or more parameters for an AI model used by the AI-related software feature.
In Example 4, the subject matter of Examples 1-3 includes, wherein the select AI-related software configuration data comprises a set of prompts for a generative AI model used by the AI-related software feature.
In Example 5, the subject matter of Example 4 includes, wherein the subset of AI-related software configuration data items comprises a prompt template that defines a prompt, wherein the prompt template comprises text and at least one of a reference to a user-defined variable or a reference to an attribute, and wherein the generating of the response comprises: generating at least one prompt of the set of prompts based on the prompt template.
In Example 6, the subject matter of Examples 4-5 includes, wherein the subset of AI-related software configuration data items comprises a prompt template that defines a prompt, wherein the prompt template comprises text and at least one of a reference to a user-defined variable or a reference to an attribute, and wherein the generating of the response comprises: generating at least one prompt of the set of prompts based on the prompt template and at least one attribute value of the set of attribute values.
In Example 7, the subject matter of Examples 1-6 includes, wherein the stored data comprises a set of target rules, and wherein the determining of the subset of the set of AI-related software configuration data items based on the one or more attribute values from the set of attribute values comprises: evaluating a subset of the set of target rules based on the one or more attribute values to generate an evaluation result; and identifying the subset of the set of AI-related software configuration data items based on the evaluation result.
In Example 8, the subject matter of Examples 1-7 includes, wherein the generating of the select AI-related software configuration data based on the subset of AI-related software configuration data items comprises: including at least one AI-related software configuration data item from the subset of AI-related software configuration data items in the select AI-related software configuration data.
In Example 9, the subject matter of Examples 1-8 includes, wherein the operations comprise: receiving tracking data from the deployed software application, the tracking data being associated with a select AI configuration variation of the group of different AI configuration variations identified by the configuration key.
In Example 10, the subject matter of Example 9 includes, wherein the operations comprise: tracking metrics separately for different AI configuration variations of the group of AI configuration variations, the tracking of the metrics for the different AI configuration variations comprising: updating at least one tracked metric based on a metric from the tracking data; and comparing performance between the different AI configuration variations based on the tracked metrics.
In Example 11, the subject matter of Examples 9-10 includes, wherein the operations comprise: causing display of a graphical user interface on a client device, the graphical user interface displaying monitoring information associated with the individual AI configuration variation, the monitoring information being generated based on at least a portion of the tracking data.
In Example 12, the subject matter of Examples 9-11 includes, wherein the tracking data comprises at least one of: one or more duration metrics; one or more token usage metrics; one or more generation success metrics; one or more generation error metrics; one or more time to first token metrics; and one or more output satisfaction metrics.
In Example 13, the subject matter of Examples 9-12 includes, wherein the operations comprise: detecting a regression in performance in association with the AI-related software feature based on at least a portion of the tracking data; and in response to detecting the regression in performance, causing the AI-related software feature to use a previous version of the AI-related software configuration data.
In Example 14, the subject matter of Examples 9-13 includes, wherein the operations comprise: correlating the tracking data with one or more experiments being conducted with respect to the AI-related software feature.
In Example 15, the subject matter of Examples 1-14 includes, wherein the stored data comprises a feature flag associated with the AI-related software feature.
In Example 16, the subject matter of Examples 1-15 includes, wherein the sending of the response to the deployed software application on the remote computing device comprises: using a flag delivery network to send the response to the deployed software application on the remote computing device.
In Example 17, the subject matter of Example 16 includes, wherein the request is received over the flag delivery network.
Example 18 is a method to implement any of Examples 1-17.
Example 19 is at least one machine storage medium comprising instructions that, when executed by a processor, cause the processor to perform operations to implement any of Examples 1-17.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 704 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to some example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The detailed description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. The terms “a” or “an” should be read as meaning “at least one,” “one or more,” or the like. The use of words and phrases such as “one or more,” “at least,” “but not limited to,” or other like phrases shall not be read to mean that the narrower case is intended or required in instances where such broadening phrases may be absent.

Boundaries between various resources, operations, components, engines, and data stores are somewhat arbitrary, and particular operations are illustrated in a context of specific illustrative configurations. Other allocations of functionality are envisioned and may fall within a scope of various example embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The description above includes systems, methods, devices, instructions, and computer media (e.g., computing machine program products) that embody illustrative embodiments of the disclosure. In the description, for the purposes of explanation, numerous specific details are set forth in order to provide an understanding of various example embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

What is claimed is:

1. A system comprising:
a processor; and
a memory storing instructions that, when executed by the processor, cause the system to perform operations comprising:
receiving a request, from a deployed software application operating on a remote computing device, for AI configuration information, the request comprising a configuration key that identifies a group of different AI configuration variations, the request comprising context data that comprises a set of attribute values associated with an entity of the deployed software application;
retrieving, from a data store, stored data associated with the configuration key, the stored data comprising a set of AI-related software configuration data items;
generating a response to the request based on at least a portion of the stored data, the response comprising select AI-related software configuration data, the generating of the response comprising:
determining, based on one or more attribute values from the set of attribute values, a subset of the set of AI-related software configuration data items, the subset of AI-related software configuration data corresponding to an individual AI configuration variation of the group of different AI configuration variations; and
generating the select AI-related software configuration data based on the subset of AI-related software configuration data items; and
sending the response to the deployed software application on the remote computing device, an AI-related software feature of the deployed software application operating based on the select AI-related software configuration data from the received response.

2. The system of claim 1, wherein the select AI-related software configuration data comprises AI model information for an AI model used by the AI-related software feature.

3. The system of claim 1, wherein the select AI-related software configuration data comprises one or more parameters for an AI model used by the AI-related software feature.

4. The system of claim 1, wherein the select AI-related software configuration data comprises a set of prompts for a generative AI model used by the AI-related software feature.

5. The system of claim 4, wherein the subset of AI-related software configuration data items comprises a prompt template that defines a prompt, wherein the prompt template comprises text and at least one of a reference to a user-defined variable or a reference to an attribute, and wherein the generating of the response comprises:
generating at least one prompt of the set of prompts based on the prompt template.

6. The system of claim 4, wherein the subset of AI-related software configuration data items comprises a prompt template that defines a prompt, wherein the prompt template comprises text and at least one of a reference to a user-defined variable or a reference to an attribute, and wherein the generating of the response comprises:
generating at least one prompt of the set of prompts based on the prompt template and at least one attribute value of the set of attribute values.

7. The system of claim 1, wherein the stored data comprises a set of target rules, and wherein the determining of the subset of the set of AI-related software configuration data items based on the one or more attribute values from the set of attribute values comprises:
evaluating a subset of the set of target rules based on the one or more attribute values to generate an evaluation result; and
identifying the subset of the set of AI-related software configuration data items based on the evaluation result.

8. The system of claim 1, wherein the generating of the select AI-related software configuration data based on the subset of AI-related software configuration data items comprises:
including at least one AI-related software configuration data item from the subset of AI-related software configuration data items in the select AI-related software configuration data.

9. The system of claim 1, wherein the operations comprise:
receiving tracking data from the deployed software application, the tracking data being associated with a select AI configuration variation of the group of different AI configuration variations identified by the configuration key.

10. The system of claim 9, wherein the operations comprise:
tracking metrics separately for different AI configuration variations of the group of AI configuration variations, the tracking of the metrics for the different AI configuration variations comprising:
updating at least one tracked metric based on a metric from the tracking data; and
comparing performance between the different AI configuration variations based on the tracked metrics.

11. The system of claim 9, wherein the operations comprise:
causing display of a graphical user interface on a client device, the graphical user interface displaying monitoring information associated with the individual AI configuration variation, the monitoring information being generated based on at least a portion of the tracking data.

12. The system of claim 9, wherein the tracking data comprises at least one of:
one or more duration metrics;
one or more token usage metrics;
one or more generation success metrics;
one or more generation error metrics;
one or more time to first token metrics; and
one or more output satisfaction metrics.

13. The system of claim 9, wherein the operations comprise:
detecting a regression in performance in association with the AI-related software feature based on at least a portion of the tracking data; and
in response to detecting the regression in performance, causing the AI-related software feature to use a previous version of the AI-related software configuration data.

14. The system of claim 9, wherein the operations comprise:
correlating the tracking data with one or more experiments being conducted with respect to the AI-related software feature.

15. The system of claim 1, wherein the stored data comprises a feature flag associated with the AI-related software feature.

16. The system of claim 1, wherein the sending of the response to the deployed software application on the remote computing device comprises:
using a flag delivery network to send the response to the deployed software application on the remote computing device.

17. The system of claim 16, wherein the request is received over the flag delivery network.

18. A method comprising:
receiving a request, by a processor and from a deployed software application operating on a remote computing device, for AI configuration information, the request comprising a configuration key that identifies a group of different AI configuration variations, the request comprising context data that comprises a set of attribute values associated with an entity of the deployed software application;
retrieving, by the processor and from a data store, stored data associated with the configuration key, the stored data comprising a set of AI-related software configuration data items;
generating, by the processor, a response to the request based on at least a portion of the stored data, the response comprising select AI-related software configuration data, the generating of the response comprising:
determining, based on one or more attribute values from the set of attribute values, a subset of the set of AI-related software configuration data items, the subset of AI-related software configuration data corresponding to an individual AI configuration variation of the group of different AI configuration variations; and
generating the select AI-related software configuration data based on the subset of AI-related software configuration data items; and
sending, by the processor, the response to the deployed software application on the remote computing device, an AI-related software feature of the deployed software application operating based on the select AI-related software configuration data from the received response.

19. The method of claim 18, comprising:
receiving, by the processor, tracking data from the deployed software application, the tracking data being associated with a select AI configuration variation of the group of different AI configuration variations identified by the configuration key.

20. A machine storage medium including instructions that when executed by a processor, cause the processor to perform operations comprising:
receiving a request, from a deployed software application operating on a remote computing device, for AI configuration information, the request comprising a configuration key that identifies a group of different AI configuration variations, the request comprising context data that comprises a set of attribute values associated with an entity of the deployed software application;
retrieving, from a data store, stored data associated with the configuration key, the stored data comprising a set of AI-related software configuration data items;
generating a response to the request based on at least a portion of the stored data, the response comprising select AI-related software configuration data, the generating of the response comprising:
determining, based on one or more attribute values from the set of attribute values, a subset of the set of AI-related software configuration data items, the subset of AI-related software configuration data corresponding to an individual AI configuration variation of the group of different AI configuration variations; and
generating the select AI-related software configuration data based on the subset of AI-related software configuration data items; and
sending the response to the deployed software application on the remote computing device, an AI-related software feature of the deployed software application operating based on the select AI-related software configuration data from the received response.
